(19) United States
(12) Patent Application Publication
(10) Pub. No.: US 2026/0169491 A1
(43) Pub. Date: Jun. 18, 2026

(54) ELECTRONIC DEVICE AND METHOD WITH AUTONOMOUS DRIVING PATH PLANNING

(71) Applicants: Samsung Electronics Co., Ltd., Suwon-si (KR); Seoul National University R&DB Foundation, Seoul (KR)

(72) Inventors: Joonwoo AHN, Suwon-si (KR); Jaeheung PARK, Yongin-si (KR); Minsoo KIM, Seoul (KR); Seho SHIN, Suwon-si (KR); Arthur Paul Louis ESQUERRE-POURTERE, Seoul (KR); Dongwook LEE, Suwon-si (KR)

(73) Assignees: Samsung Electronics Co., Ltd., Suwon-si (KR); Seoul National University R&DB Foundation, Seoul (KR)

(21) Appl. No.: 19/249,157

(22) Filed: Jun. 25, 2025

(30) Foreign Application Priority Data
Dec. 18, 2024 (KR) 10-2024-0189888

(51) Int. Cl. G05D 1/644; G05D 1/622; G05D 101/10; G05D 109/10

(52) U.S. Cl. CPC G05D 1/644; G05D 1/622; G05D 2101/10; G05D 2109/10

(57) ABSTRACT

A processor-implemented method includes determining whether a moving object has reached a target node, in response to the moving object not reaching the target node, determining a first optimal node and a first optimal edge through which the moving object passes to reach the target node from a current location of the moving object, inputting obstacle information around the moving object, the target node, the first optimal node, and the first optimal edge to an artificial intelligence (AI) model, determining a candidate node through which the moving object is likely to pass after reaching the first optimal node to reach the target node, based on a confidence of an output of the AI model included in the output of the AI model, and determining an optimal path for the moving object to reach the target node based on one or more candidate nodes including the candidate node.

### CROSS-REFERENCE TO RELATED APPLICATIONS

This application claims the benefit under 35 USC § 119 (a) of Korean Patent Application No. 10-2024-0189888, filed on Dec. 18, 2024, in the Korean Intellectual Property Office, the entire disclosure of which is incorporated herein by reference for all purposes.

### BACKGROUND

### 1. Field

The following description relates to an electronic device and method with autonomous driving path planning.

### 2. Description of Related Art

Home robots, industrial robots, and autonomous driving devices may autonomously travel at various places such as homes, offices, public places, and the like. Path planning (e.g., motion planning) may be required for autonomous driving of various moving objects (e.g., mobile robots, autonomous vehicles, unmanned aerial vehicles (drones), and the like). Path planning may be a process by which a moving object searches for an optimal path to move to a target point while avoiding collisions in a given environment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining whether a moving object has reached a target node, in response to the moving object not reaching the target node, determining a first optimal node and a first optimal edge through which the moving object passes to reach the target node from a current location of the moving object, inputting obstacle information around the moving object, the target node, the first optimal node, and the first optimal edge to an artificial intelligence (AI) model, determining a candidate node through which the moving object is likely to pass after reaching the first optimal node to reach the target node, based on a confidence of an output of the AI model included in the output of the AI model, and determining an optimal path for the moving object to reach the target node based on one or more candidate nodes including the candidate node.

The AI model may be configured to output a first distribution of the optimal path based on the first optimal node, the confidence of the first distribution, and a second distribution of the optimal path based on a target tree generated from the target node, based on the obstacle information, the target node, the first optimal node, and the first optimal edge.

The determining of the first optimal node and the first optimal edge may include, in response to the current location of the moving object being on an edge, until the moving object reaches a node connected to the edge, determining the node and the edge to be the first optimal node and the first optimal edge, respectively.

The determining of the first optimal node and the first optimal edge may include, in response to the current location of the moving object being on a node, determining the first optimal node and the first optimal edge among one or more candidate nodes determined while the moving object moves from a previous node of the node to the node and one or more candidate edges corresponding to the one or more candidate nodes.

The method may include determining the one or more candidate nodes by repeating the determining of the first optimal node and the first optimal edge, the inputting to the AI model, and the determining of the candidate node, until the moving object reaches the first optimal node.

The determining of the candidate node may include determining the candidate node based on any one of the first distribution, the second distribution, and an area comprising the first distribution and the second distribution.

The candidate node may be more likely to be determined from the first distribution, the higher the confidence is.

The determining of the candidate node may include any one of determining the candidate node based on the first distribution, in response to a random value being less than a second parameter, determining the candidate node based on the second distribution, in response to the random value being greater than or equal to the second parameter and less than a predetermined value, and determining the candidate node based on the area comprising the first distribution and the second distribution, in response to the random value being greater than or equal to the predetermined value.

The second parameter may correspond to a probability of determining the candidate node from the second distribution, and the predetermined value may be determined based on the confidence of the output of the AI model, the second parameter, and a first parameter corresponding to a probability of determining the candidate node from the first distribution with a maximum usage ratio.

The determining of the optimal path may include, in response to the moving object reaching the first optimal node, determining a second optimal node among the one or more candidate nodes, removing candidate nodes other than the second optimal node from among the one or more candidate nodes, and removing candidate edges other than a second optimal edge corresponding to the second optimal node from among one or more candidate edges corresponding to the one or more candidate nodes, and determining the optimal path based on the second optimal node and the second optimal edge.

The determining of the second optimal node may include, in response to there being no candidate node connected to the target tree generated from the target node among one or more candidate nodes, determining a candidate node configured to be connected to the target node by the shortest distance among the one or more candidate nodes to be the second optimal node and the second optimal edge.

The determining of the second optimal node may include, in response to there being a candidate node connected to the target tree generated from the target node among the one or more candidate nodes, determining the candidate node connected to the target tree to be the second optimal node.

In one or more general aspects, an electronic device includes one or more processors configured to determine whether a moving object has reached a target node, in response to the moving object not reaching the target node, determine a first optimal node and a first optimal edge through which the moving object passes to reach the target node from a current location of the moving object, input obstacle information around the moving object, the target node, the first optimal node, and the first optimal edge to an artificial intelligence (AI) model, determine a candidate node through which the moving object is likely to pass after reaching the first optimal node to reach the target node based on a confidence of an output of the AI model included in the output of the AI model, and determine an optimal path for the moving object to reach the target node based on one or more candidate nodes including the candidate node.

The AI model may be configured to output a first distribution of the optimal path based on the first optimal node, the confidence of the first distribution, and a second distribution of the optimal path based on a target tree generated from the target node, based on the obstacle information, the target node, the first optimal node, and the first optimal edge.

The one or more one processors may be configured to, in response to the current location of the moving object being on an edge, until the moving object reaches a node connected to the edge, determine the node and the edge to be the first optimal node and the first optimal edge, respectively.

The one or more one processors may be configured to, in response to the current location of the moving object being on a node, determine the first optimal node and the first optimal edge among one or more candidate nodes determined while the moving object moves from a previous node of the node to the node and one or more candidate edges corresponding to the one or more candidate nodes.

The one or more one processors may be configured to determine the one or more candidate nodes by repeating the determining of the first optimal node and the first optimal edge, the inputting to the AI model, and the determining of the candidate node, until the moving object reaches the first optimal node.

The one or more one processors may be configured to determine the candidate node based on any one of the first distribution, the second distribution, and an area comprising the first distribution and the second distribution.

The one or more one processors may be configured to in response to the moving object reaching the first optimal node, determine a second optimal node among the one or more candidate nodes, remove candidate nodes other than the second optimal node from among the one or more candidate nodes, and remove candidate edges other than a second optimal edge corresponding to the second optimal node from among one or more candidate edges corresponding to the one or more candidate nodes, and determine the optimal path based on the second optimal node and the second optimal edge.

In one or more general aspects, a processor-implemented method includes inputting, to an artificial intelligence (AI) model, obstacle information around a moving object, a target node, a first optimal node, and a first optimal edge through which the moving object passes to reach the target node from a current location of the moving object, determining, based on a confidence included in an output of the AI model, a candidate node through which the moving object is likely to pass after reaching the first optimal node to reach the target node, based on a selected one of a first distribution of the optimal path determined based on the first optimal node, a second distribution of the optimal path determined based on a target tree generated from the target node, and an area comprising the first distribution and the second distribution, and determining an optimal path for the moving object to reach the target node based on one or more candidate nodes including the candidate node.

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of a method of planning an optimal path in autonomous driving for autonomous parking.

FIG. 3 illustrates an example of an operation of an electronic device.

FIG. 4 illustrates an example of an initial phase.

FIG. 5 illustrates an example of a method of selecting an optimal node and an optimal path.

FIG. 6 illustrates an example of a method of determining a candidate node through sampling.

FIGS. 7 and 8 illustrate examples of an iterative phase.

FIG. 9 illustrates an example of an artificial intelligence model.

FIG. 10 illustrates an example of an operating method of an electronic device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, examples will be described in detail with reference to the accompanying drawings. When describing the examples with reference to the accompanying drawings, like reference numerals refer to like components.

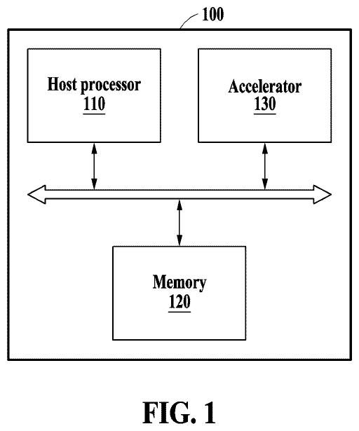

FIG. 1 illustrates an example of an electronic device.

Referring to FIG. 1, an electronic device 100 may include a host processor 110 (e.g., one or more processors), memory 120 (e.g., one or more memories), and an accelerator 130 (e.g., one or more accelerators). The host processor 110, memory 120, and accelerator 130 may communicate with each other through a bus, network on a chip (NoC), peripheral component interconnect express (PCIe), and the like. The electronic device 100 shown in FIG. 1 only illustrates components related to the examples of the disclosure. Therefore, it will be apparent to those skilled in the art with an understanding of this disclosure that the electronic device 100 may further include other general components in addition to the components illustrated in FIG. 1.

The host processor 110 may perform overall functions for controlling the electronic device 100. The host processor 110 may control overall operations of the electronic device 100 by executing programs and/or instructions stored in the memory 120. For example, the memory 120 may be or include a non-transitory computer-readable storage medium storing code that, when executed by the host processor 110, configures the host processor 110 to perform any one, any combination, or all of operations and/or methods disclosed herein with reference to FIGS. 1-10. The host processor 110 may be implemented as a central processing unit (CPU), a graphics processing unit (GPU), an application processor (AP), and/or the like, but is not limited thereto.

The memory 120 may be hardware storing data processed and/or data to be processed within the electronic device 100. In addition, the memory 120 may store applications, drivers, and the like to be driven by the electronic device 100. The memory 120 may include volatile memory such as dynamic random access memory (DRAM) and/or nonvolatile memory.

The electronic device 100 may include the accelerator 130 for computation. The accelerator 130 may process tasks that are more efficient to process on a separate dedicated processor, i.e., the accelerator 130, rather than on a general-purpose host processor 110 due to the nature of computation. For example, a large language model (LLM) may be executed on the accelerator 130. In this example, one or more processing elements (PEs) included in the accelerator 130 may be utilized. The accelerator 130 may be, for example, a neural processing unit (NPU), a tensor processing unit (TPU), a digital signal processor (DSP), a GPU, a neural engine, and the like that perform computation according to a neural network. It will be apparent to those skilled in the art with an understanding of this disclosure that tasks that are more efficient to process in the accelerator 130 may not necessarily be processed in the accelerator 130 but may instead be processed by the host processor 110.

The electronic device 100 may be, or be included in, a moving object. The electronic device 100 may be, or be included in, a moving object performing autonomous driving to plan an optimal path of the moving object. The moving object may be controlled to follow an optimal path planned by the electronic device 100. The moving object may include a domestic robot, an industrial robot, an autonomous vehicle, and/or a drone. The electronic device 100 may plan an optimal path and/or allow the moving object to avoid obstacles in a task of reaching a particular destination in a narrow environment.

Hereinafter, an example of the planning of an optimal path is described.

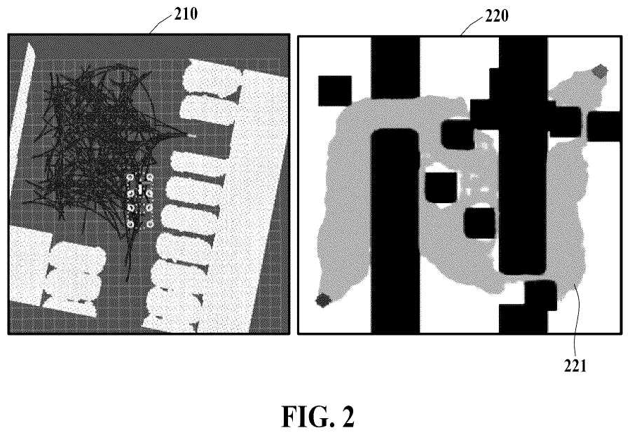

FIG. 2 illustrates an example of a method of planning an optimal path in autonomous driving for autonomous parking.

Referring to FIG. 2, a moving object performing autonomous driving may be a moving object configured to autonomously drive without the intervention of a driver. The moving object may be implemented as an autonomous driving device, but is not necessarily limited thereto, and may be implemented as various transportation schemes such as a two-wheeled autonomous driving device, a robot, an aircraft, and the like. It will be apparent to those skilled in the art with an understanding of this disclosure that the moving object described in the present disclosure may be any one of the various transportation schemes described above.

The moving object may be or include an electronic device. The moving object may be controlled by the electronic device. The moving object may be controlled by the electronic device to drive in an autonomous mode based on a recognized driving environment. The autonomous mode may refer to a moving object equipped with an automated lane keeping system driving in a single lane at a speed below a predetermined level. The driving environment may be recognized by the electronic device through sensors attached and/or installed on the moving object. The sensors may include a camera, LIDAR, RADAR, and voice recognition sensors, but are not limited to the described examples. The driving environment may include, but is not limited to, roads, road conditions, types of lanes, the presence or absence of surrounding moving objects, distances to adjacent vehicles, the weather, the presence or absence of obstacles, and the like.

The electronic device may recognize a driving environment of the moving object and generate a driving path (e.g., an optimal path) appropriate for the driving environment. The mechanical elements inside and outside the moving object may be controlled by the electronic device to follow the driving path. The electronic device may iteratively generate the driving path.

The electronic device may plan a path in advance of driving to generate a driving path. Path planning may be a scheme of generating as many random paths as possible. The electronic device may perform path planning based on a sampling-based algorithm. A representative sampling-based algorithm may be a rapidly-exploring random tree star (RRT*) algorithm.

Referring to example 210, the RRT* algorithm may basically generate a path by growing a tree from a starting point to a target point over an entire state space. Performing sampling over the entire state space may be referred to as uniform sampling. The RRT* algorithm may have an advantage of being robust to high-dimensional and multi-constrained path generation issues. However, since a typical RRT* algorithm samples the entire space, it may have slow convergence speed, large memory requirements, and issues due to path generation delay in narrow passages.

Referring to example 220, instead of performing uniform sampling, the electronic device may preemptively determine an area 221 (e.g., a distribution) in which an optimal path is likely to exist and perform sampling in that area 221. Performing sampling in a partial area of the state space may be referred to as non-uniform sampling. The area 221 in which an optimal path is likely to exist may be referred to as a feasible path distribution (FPD). An artificial intelligence (AI) model may be used to obtain an FPD.

Although not shown in FIG. 2, Anytime-RRT* may be a real-time path planning algorithm for a moving object. Anytime-RRT* may search for a non-optimal initial path for a short period of time and search for a path with lower cost (e.g., a quickest path and/or a path of a shortest distance) as the path searching process progresses. Anytime-RRT* may be an algorithm that plans and follows a path in real time. Anytime-RRT* may include an initial phase and an iterative phase.

The initial phase may be performed for a defined amount of time. When the initial phase is completed, an optimal edge for the moving object to follow may be determined. The optimal edge may be a path that the moving object follows, which may be referred to as a commit trajectory and/or commit path. An optimal node located at the end of the optimal edge may become a new root for tree generation.

In the iterative phase, the moving object may follow the optimal edge. While the moving object follows the optimal edge, new candidate nodes may be continuously generated based on the optimal edge. When the moving object reaches the optimal node of the optimal edge being followed, an optimal edge may be determined again. The iterative phase may be performed until the moving object reaches a target point (e.g., a target node).

An AI model may be used for Anytime-RRT*. Since a typical AI model is trained based on a training data set, the accuracy of prediction may decrease in an unfamiliar environment with dynamic environmental changes and increasing uncertainty that may be difficult to predict from the training data set. For example, in a narrow environment with many obstacles in a driving environment, the accuracy of prediction may decrease and the prediction may take a long time. To overcome the above-described issue, an AI model with a larger size may be required. However, there may be an issue that it is expensive to include a large AI model in the electronic device that is mounted on the moving object.

Hereinafter, an example of a method in which the electronic device performs path planning in an unfamiliar environment with dynamic environmental changes and increasing uncertainty is described.

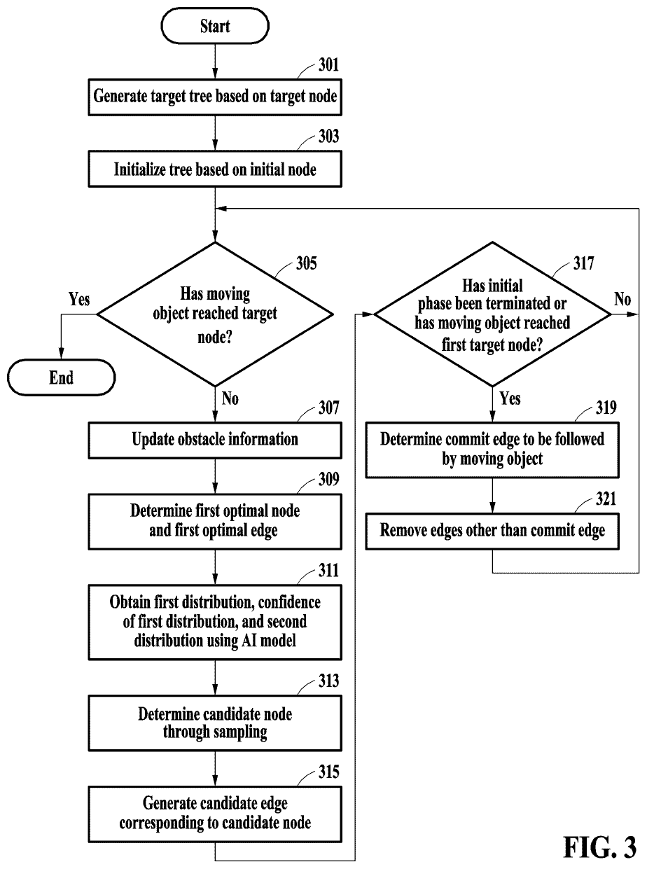

FIG. 3 illustrates an example of an operation of an electronic device.

Operations 301 to 321 of FIG. 3 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein. The operations illustrated in FIG. 3 may be performed by at least one component of the electronic device. For example, the electronic device may perform the following operations when instructions included in the memory are individually and/or collectively executed by a processor. The processor may include at least one of a host processor and an accelerator.

In operation 301, the electronic device may generate a target tree [symbol] _{target} based on a target node x_{goal}.

The target node may represent a destination to be reached by a moving object including the electronic device during autonomous driving. The target tree may be generated from the target node. The target tree may include a plurality of target edges based on the target node.

In operation 303, the electronic device may initialize a tree [symbol] _{RRT} based on an initial node Xᵢₙᵢₜ.

The initial node may represent a position at which the moving object is stationary before starting moving or driving. The electronic device may initialize the tree based on the initial node. Since the moving object is stationary, only a root corresponding to the initial node may be included in the tree as the tree is initialized.

In operation 305, the electronic device may determine whether the moving object has reached the target node.

When the moving object has not reached the target node, the electronic device may perform operation 307. When the moving object has reached the target node, the electronic device may terminate the planning of an optimal path.

In operation 307, the electronic device may update obstacle information.

The obstacle information may include information on an area in which the moving object may drive and an area in which the moving object may not drive (e.g., due to another object obstructing the movement of the moving object) in a driving environment. The obstacle information may be updated as the moving object drives.

In operation 309, the electronic device may determine a first optimal node x_{best} and a first optimal edge π_{best}.

The first optimal node may be a node that the moving object passes through when moving to a target node by following an optimal path. The first optimal edge may be a path from a previous node (e.g., a node previous to the first optimal node that the moving object passed through) to the first optimal node.

In the initial phase, since the moving object is stationary, the initial node of the electronic device may be determined to be the first optimal node. In the initial phase, since the electronic device is stationary, the first optimal edge may be determined to be a driving path of the initial node.

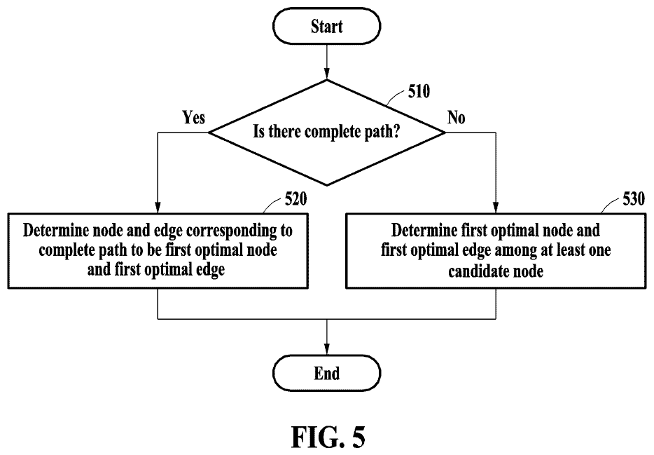

An example of a method of determining the first optimal node and the first optimal edge is further described in FIG. 5.

In operation 311, the electronic device may obtain a first distribution \hat{P}_{seg+1}, a confidence [symbol] of the first distribution, and a second distribution [symbol] ₜₐᵣ.

The electronic device may input the obstacle information, the target node, the first optimal node, and the first optimal edge to an AI model. The AI model may output the first distribution of an optimal path based on the first optimal node, the confidence of the first distribution, and a second distribution of the optimal path based on the target tree generated from the target node, based on the obstacle information, the target node, the first optimal node, and the first optimal edge.

In the initial phase, the AI model may output the first distribution of the optimal path based on the initial node, the confidence of the first distribution, the second distribution of the optimal path based on the target tree generated from the target node, based on the obstacle information, the target node, the first optimal node, and the first optimal edge.

The first distribution of the optimal path may be an area on the moving object side where the optimal node is likely to be disposed for planning the optimal path. For example, the first distribution of the optimal path may be an area on the moving object side where a likelihood of the optimal node being disposed for planning the optimal path exceeds a threshold value.

The second distribution of the optimal path may be an area on the target tree side where the optimal node is likely to be disposed for planning the optimal path. For example, the second distribution of the optimal path may be an area on the target tree side where a likelihood of the optimal node being disposed for planning the optimal path exceeds a threshold value.

The confidence of the first distribution may be a degree to which the first distribution output by the AI model is reliable. The confidence may be determined as a value between “0” and “1”. The closer the confidence is to “1”, the higher the degree to which the first distribution may be reliable.

In operation 313, the electronic device may determine a candidate node x_{rand} through sampling.

The electronic device may determine a candidate node through sampling based on parameters and outputs of the AI model. The electronic device may determine the candidate node through sampling based on the first distribution, the confidence of the first distribution, the second distribution, a first parameter λₘₐₓ, and a second parameter [symbol] .

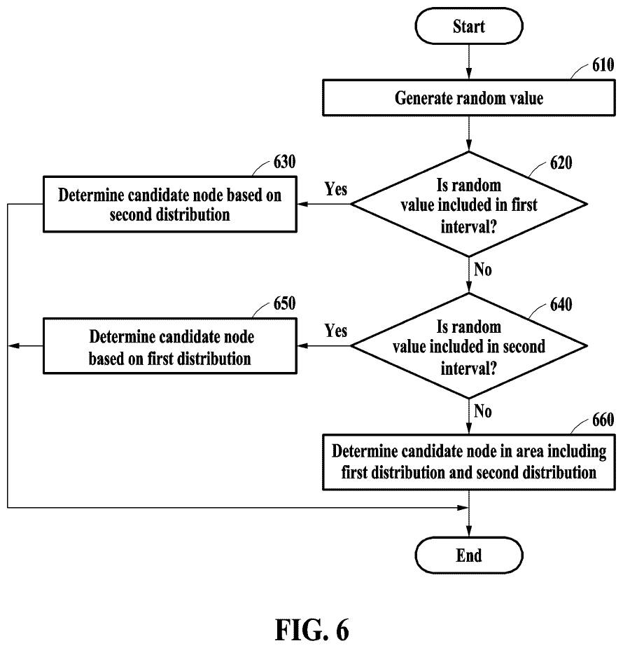

The candidate node may be determined based on three sampling schemes. An example of a method of determining the candidate node is further described in FIG. 6.

There may be at least one candidate node. For example, a candidate node may be determined whenever “no” is determined in operation 317 of FIG. 3. A candidate node through which the moving object is likely to pass may be determined whenever “no” is determined in operation 317 of FIG. 3.

In operation 315, the electronic device may generate a candidate edge corresponding to a candidate node.

The electronic device may generate a candidate edge by connecting the first optimal node and the candidate node. The candidate edge connected between the first optimal node and the candidate node may be a branch of a tree rooted at the first optimal node. In the initial phase, the candidate edge may be a branch of the tree generated in operation 303 rooted at the initial node.

In operation 317, the electronic device may determine whether the initial phase has been terminated and/or whether the moving object has reached the first target node.

In operation 317, when the initial phase has not been terminated and/or the moving object has not reached the first target node as the moving object moves, the electronic device may perform operation 305.

When a time defined to perform the initial phase has not elapsed, the initial phase may not be terminated. When the time defined to perform the initial phase has not elapsed, the electronic device may perform operation 305 to the operation 317 again. When the time defined to perform the initial phase has not elapsed, the electronic device may perform the determining of whether the moving object has reached the target node, the updating of the obstacle information, the determining of the first optimal node and the first optimal edge, the obtaining of the first distribution, the confidence of the first distribution, and the second distribution, the determining of the candidate node, and the generating of the candidate edge. For example, operations 305 to 317 may be iteratively performed until the initial phase is terminated. Whenever operations 305 to 317 are iteratively performed in the initial phase, a branch (e.g., a candidate edge) of a tree rooted at the initial node may be generated.

When the initial phase is terminated, the moving object may move. When the first optimal node has not been reached as the moving object moves, the electronic device may perform operations 305 to 317 again. When the moving object has not reached the first optimal node, the electronic device may perform the determining of whether the moving object has reached the target node, the updating of the obstacle information, the determining of the first optimal node and the first optimal edge, the obtaining of the first distribution, the confidence of the first distribution, and the second distribution, the determining of the candidate node, and the generating of the candidate edge. For example, operations 305 to 317 may be repeatedly iteratively until the moving object reaches the first optimal node. Whenever operations 305 to 317 are iteratively performed, a branch (e.g., a candidate edge) of a tree rooted at the first optimal node may be generated.

In operation 317, when the initial phase has been terminated, and/or the first optimal node has been reached as the moving object moves, the electronic device may perform operation 319.

In operation 319, the electronic device may determine a commit edge to be followed by the moving object.

When the initial phase has been terminated, a commit edge may be determined among branches of a tree rooted at the initial node. The branches of the tree may be candidate edges that each connect the initial node to at least one candidate node. The electronic device may determine any one of the at least one candidate nodes to be a commit edge. The electronic device may determine an optimal path by determining any one of the at least one candidate nodes to be the commit edge.

A method of determining any one of the at least one candidate nodes to be the commit edge may be the same as the method of determining the first optimal node and the first optimal edge of operation 309.

When the moving object has reached the first optimal node, the commit edge may be determined among the branches of the tree rooted at the first optimal node. The tree rooted at the first optimal node may include candidate edges each connecting the first optimal node and the at least one candidate node. The electronic device may determine any one of at least one candidate edge corresponding to the at least one candidate node to be a commit edge. The electronic device may determine an optimal path by determining any one of the at least one candidate edge to be the commit edge. A method of determining any one of the at least one candidate edge to be the commit edge may be the same as the method of determining the first optimal node and the first optimal edge of operation 309.

In operation 321, the electronic device may remove edges other than the commit edge. The electronic device may reduce the amount of computation by removing edges other than the commit edge from the tree.

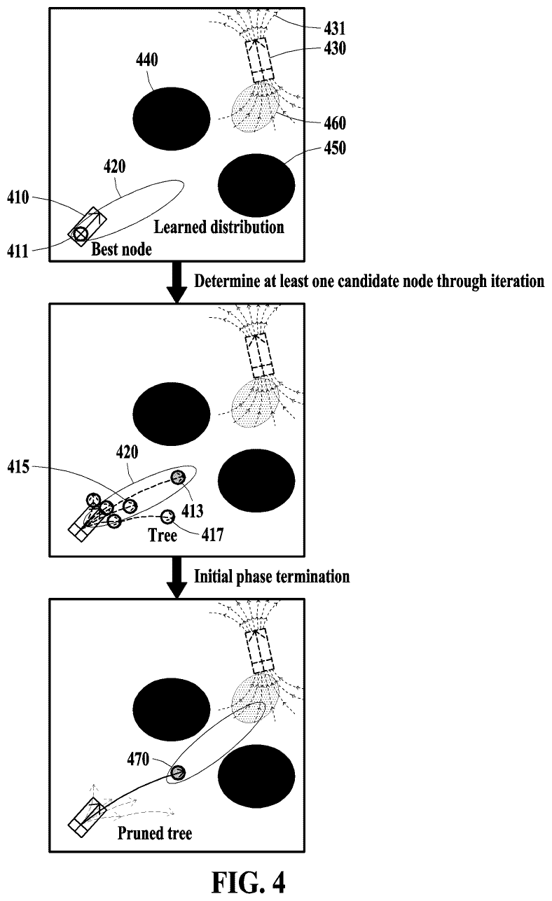

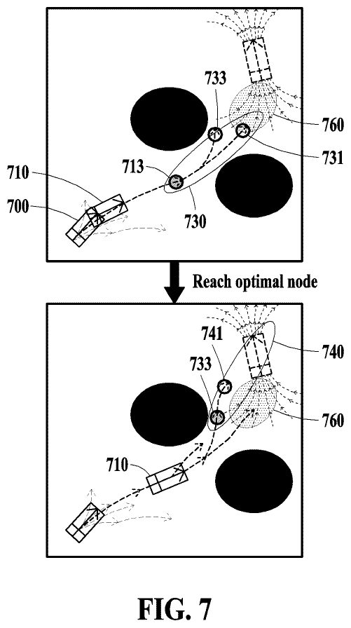

Examples of operations of the initial phase are described in more detail with reference to FIG. 4, and examples of operations of the iterative phase are described in more detail with reference to FIGS. 6 and 7.

FIG. 4 illustrates an example of an initial phase.

Referring to FIG. 4, a moving object 410 and a target position 430 of the moving object in the initial phase are illustrated. The target position 430 may include a final position of the moving object and a posture of the moving object. An electronic device of the moving object 410 may plan a path to reach the target position 430 in a driving environment in which obstacles 440 and 450 exist. The moving object 410 may be located at an initial node 411 and may be stationary.

The electronic device may generate a target tree 431 based on a target node. The target tree 431 may include a plurality of target edges generated based on the target node. Each of the target edges may correspond to a driving path that allows the moving object 410 to drive to the target node (e.g., a driving path along which the moving object 410 would successfully reach the target node (e.g., by avoiding coming into contact with any obstacle)). The electronic device may generate the target edges by planning a driving path to reach the target node in advance (e.g., in advance of driving from the initial node 411) based on the driving environment around the target node. When the moving object 410 reaches (e.g., moves to) the target edge, the moving object 410 may drive to the target node according to the target edge without having to plan a separate path.

The electronic device may initiate (e.g., generate) a tree based on the initial node 411. The electronic device may determine whether the moving object 410 has reached the target node.

The electronic device may update obstacle information. The electronic device may identify a free area in which the moving object 410 may drive by updating the obstacle information. For example, the electronic device may update a position, size, shape, and/or the like of the obstacle 440 and the obstacle 450.

The electronic device may determine a first optimal node and a first optimal edge. In the initial phase, when the moving object is stationary, the initial node 411 of the electronic device may be determined to be the first optimal node. In the initial phase, when the electronic device is stationary, the first optimal edge may be determined to be a driving path (e.g., stationary) to the initial node 411.

The electronic device may input the obstacle information, the target node, the first optimal node, and the first optimal edge to an AI model. The AI model may output a first distribution 420, a confidence of the first distribution 420, and a second distribution 460. Examples of the first distribution 420, the confidence, and the second distribution 460 are described in detail with reference to FIG. 3, so a detailed description thereof is omitted.

The electronic device may determine candidate nodes through sampling based on parameters and an output of the AI model. Through sampling, a portion of the candidate nodes may be determined within the first distribution 420. Through sampling, a portion of the candidate nodes may be determined outside the first distribution 420. Although not shown in FIG. 4, through sampling, a portion of the candidate nodes may be determined within the second distribution 460. The electronic device may generate a candidate edge by connecting a candidate node and the initial node.

The electronic device may determine at least one candidate node by iterating the operations of determining the candidate nodes described above until the initial phase is terminated.

Referring to FIG. 4, at least one candidate node 413, 415, and/or 417 determined by iterating the operations of determining the candidate nodes is illustrated. A line connecting the initial node 411 and the at least one candidate node 413, 415, and/or 417 may be a candidate edge. The initial node 411, the at least one candidate node 413, 415, and/or 417, and the candidate edge corresponding to the at least one candidate node 413, 415, and/or 417 may form a tree with the initial node 411 as the root.

When the initial phase is terminated, the electronic device may determine a commit edge among at least one candidate edge corresponding to at least one candidate node. The electronic device may determine a commit edge among branches of a tree rooted at the initial node 411. The electronic device may determine a candidate edge with the lowest cost to be the commit edge. The electronic device may determine a candidate edge with the closest distance to a target node to be the commit edge. For example, a candidate edge corresponding to the candidate node 413 with the closest distance to the target node may be determined to be the commit edge.

The electronic device may remove branches (e.g. edges) other than the commit edge from a tree. For example, the electronic device may prune branches from the tree other than the commit edge.

A commit edge and a node (e.g., the candidate node 413) located at the end of the commit edge may be determined to be an optimal edge and an optimal node for determining the next path while the moving object is driving along the commit edge.

When the initial phase is terminated, the electronic device may control the moving object to drive along the commit edge. When the initial phase is terminated, an iterative phase for determining a path may be performed. For example, when the initial phase is terminated, a first distribution 470 may be generated based on the optimal node (e.g., the candidate node 413) and the determining of a path may be performed. An example of the iterative phase is further described below with reference to FIGS. 6 and 7.

Hereinafter, an example of a method of determining an optimal node and optimal edge is described.

FIG. 5 illustrates an example of a method of selecting an optimal node and an optimal path.

Operations 510 to 530 of FIG. 5 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein. The operations illustrated in FIG. 5 may be performed by at least one component of the electronic device. For example, the electronic device may perform the following operations when instructions included in the memory are individually and/or collectively executed by a processor. The processor may include at least one of a host processor and an accelerator.

In operation 510, the electronic device may determine whether there is a complete path among at least one candidate node.

A complete path may indicate that a path to a target node has been found. It may be determined that there is a complete path when a path to the target node exists, and the path may not have to be an optimal path. For example, it may be determined that there is a complete path when there is a candidate node connected to a target tree generated from the target node and a candidate edge corresponding to the candidate node.

When there is a complete path, the electronic device may perform operation 520. When there is no complete path, the electronic device may perform operation 530.

In operation 520, the electronic device may determine a node and an edge corresponding to the complete path to be a first optimal node and a first optimal edge. The electronic device may determine a candidate node and a candidate edge corresponding to the complete path among at least one candidate node to be the first optimal node and the first optimal edge. The candidate node and the candidate edge corresponding to the complete path may be input to an AI model. In another example, when there are two or more complete paths, in operation 520, the electronic device may determine, from among the two or more complete paths, a candidate node and a candidate edge corresponding to a complete path with the least cost for driving to be the first optimal node and the first optimal edge.

In operation 530, the electronic device may determine the first optimal node and the first optimal edge from among at least one candidate node.

The electronic device may determine a candidate node with the least cost for driving among at least one candidate node and a candidate edge corresponding to the candidate node to be the first optimal node and the first optimal edge.

The electronic device may determine a candidate node that may be connected to the target node by the shortest distance among at least one candidate node and a candidate edge corresponding to the candidate node to be the first optimal node and the first optimal edge. For example, a candidate node with the closest distance to the target node and a candidate edge corresponding to the candidate node may be determined to be the first optimal node and the first optimal edge.

Hereinafter, an example of a method of determining a candidate node is described.

FIG. 6 illustrates an example of a method of determining a candidate node through sampling.

Operations 610 to 660 of FIG. 6 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein. The operations illustrated in FIG. 6 may be performed by at least one component of the electronic device. For example, the electronic device may perform the following operations when instructions included in the memory are individually and/or collectively executed by a processor. The processor may include at least one of a host processor and an accelerator.

The electronic device may determine a candidate node through sampling based on parameters and an output of an AI model. The electronic device may determine a candidate node through which a moving object is likely to pass to reach a target node based on a confidence [symbol] of the output of the AI model included in the output of the AI model. The parameters may include a first parameter λₘₐₓ and a second parameter [symbol] . The first parameter may be related to (e.g., may correspond to) the probability of determining a candidate node from a first distribution \hat{P}_{seg+1} with a maximum usage ratio. For example, the maximum usage ratio may be set to “0.95”. The second parameter may be related to (e.g., may correspond to) the probability of determining a candidate node from a second distribution [symbol] ₜₐᵣ. The electronic device may determine the candidate node based on any one of the first distribution, the second distribution, and an area including the first distribution and the second distribution.

In operation 610, the electronic device may generate a random value.

The random value may be a real number between “0” and “1”.

In operation 620, the electronic device may determine whether the random value is included in a first interval. The first interval may be an interval less than the second parameter. For example, when the second parameter is “0.1” and the random value is “0.05”, the electronic device may determine that the random value is included in the first interval. For example, the electronic device may determine that the random value is included in the first interval when the random value is less than the second parameter.

In operation 620, when the random value is included in the first interval, the electronic device may perform operation 630. In operation 620, when the random value is not included in the first interval, the electronic device may perform operation 640.

In operation 630, the electronic device may determine the candidate node based on the second distribution.

The electronic device may determine the candidate node through sampling within a target tree by adding a bias toward the second distribution in the target tree. The bias toward the second distribution may be added, which may increase the likelihood of a candidate node being determined within the second distribution. The determination of a candidate node based on the second distribution may represent target-tree-oriented sampling to address narrow driving environments.

In operation 640, the electronic device may determine whether the random value is included in the second interval.

The second interval may be an interval that exceeds the second parameter and is less than a predetermined value. For example, the electronic device may determine that the random value is included in the second interval when the random value is greater than or equal to the second parameter and is less than the predetermined value. The predetermined value may be determined as expressed by Equation 1 below, for example.

$$Predetermined value \text{:} ( 1 - τ ) λ ( c ) , λ ( c ) = min ( {λ}_{max} , c ) \qquad Equation 1$$

λ(c) may be determined to be a smaller value between a confidence and the first parameter as an adaptive usage ratio. The adaptive usage ratio may be adjusted according to the confidence. The predetermined value may be determined to be a value obtained by multiplying the adaptive usage ratio by a value obtained by subtracting the second parameter from “1”.

The predetermined value may be greater as the confidence increases. The higher the confidence, the greater the second interval may be. The higher confidence, the greater the probability that a candidate node is determined from the first distribution. For example, the higher the confidence, the more accurate the output of the AI model may be. When the output of the AI model is accurate (e.g., has high confidence), it may be more efficient to determine an optimal path based on the output of the AI model.

In operation 640, the electronic device may perform operation 650 when the random value is included in the second interval. The electronic device may perform operation 660 when the random value is not included in the second interval.

In operation 650, the electronic device may determine a candidate node based on the first distribution. The electronic device may determine a candidate node by sampling within the first distribution. For example, in FIG. 4, the candidate nodes existing within the first distribution 420 may be candidate nodes determined based on the first distribution.

In operation 660, the electronic device may determine a candidate node in an area including the first distribution and the second distribution.

The area including the first distribution and the second distribution may be a free area excluding obstacles in the driving environment of the moving object. The electronic device may determine candidate nodes that are not biased toward a predetermined area through uniform sampling within the free area. For example, the candidate nodes existing outside the first distribution 420 in FIG. 4 may be candidate nodes determined through uniform sampling.

Uniform sampling may compensate for the first distribution and second distribution output by a low-performing AI model (e.g., with low confidence), which may have low predictive performance.

Hereinafter, an example of an iterative phase is described based on the determination of the optimal node and the optimal edge and the determination of the candidate node described above with reference to FIGS. 5 and 6.

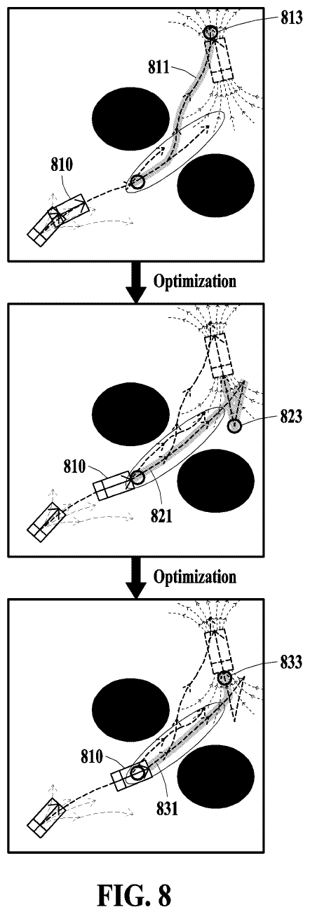

FIGS. 7 and 8 illustrate examples of an iterative phase.

Referring to FIG. 7, an example in which a complete path does not exist when an optimal node and an optimal edge are determined in the iterative phase is illustrated.

In FIG. 7, a moving object 710 departing from an initial position 700 is illustrated. When the initial phase is terminated, the moving object 710 may drive to a commit node 713 along a commit edge corresponding to the commit node 713.

The electronic device may determine a candidate node that may be determined as a next optimal node while the moving object 710 moves along the commit edge to the commit node 713 and generate a candidate edge corresponding to the candidate node.

The electronic device may determine a first optimal node and a first optimal edge. When a current location of the moving object is on an edge, the electronic device may determine the corresponding node and corresponding edge to be the first optimal node and the first optimal edge, respectively, until the moving object reaches a node connected to the edge.

For example, the moving object 710 may be on a commit edge. The electronic device may determine the commit edge and the commit node 713 to be the first optimal edge and the first optimal node, respectively.

The electronic device may input obstacle information, the target node, the first optimal node, and the first optimal edge an AI model while the moving object 710 moves to the first optimal node.

The AI model may output a first distribution 730 of an optimal path based on the first optimal node, a confidence of the first distribution 730, and a second distribution 760 of the optimal path based on a target tree generated from the target node, based on the obstacle information, the target node, the first optimal node, and the first optimal edge.

The electronic device may determine a candidate node through which the moving object 710 is likely to pass after the first optimal node to reach the target node based on the confidence of an output of the AI model included in the output of the AI model. The sampling method described above with reference to FIG. 6 may be used to determine the candidate node.

For example, the electronic device may determine a candidate node 733 within the first distribution 730.

When the candidate node is determined, the electronic device may connect the candidate node to the first optimal node to generate a candidate edge. For example, the electronic device may generate a candidate edge that connects the first optimal node (e.g., the commit node 713) and the candidate node 733.

In the iterative phase, the electronic device may determine whether the moving object 710 has reached the first optimal node. The electronic device may repeat the generating of the candidate edge and the determining of the candidate node until the moving object reaches the first optimal node. For example, at least one candidate node 731 and/or 733 may be determined through iteration of the generating of the candidate edge and the determining of the candidate node.

The moving object 710 may reach the commit node 713 (e.g., the first optimal node). When the moving object 710 reaches the commit node 713, an optimal node (e.g., a second optimal node) may be determined from the at least one candidate node.

When the moving object reaches the first optimal node, the electronic device may determine a commit edge to be followed by the moving object. For example, the electronic device may determine a candidate edge corresponding to the candidate node 733 to be the commit edge to be followed by the moving object. The candidate node 733 may be a commit node. The electronic device may remove candidate edges from the tree generated based on the first optimal node other than the candidate edges of the candidate node determined to be the commit edge.

When the moving object 710 reaches the commit node 713 (e.g., the first optimal node), operations for determining a next optimal node may be performed. When a current location of the moving object 710 is on a node, the electronic device may determine an optimal node and an optimal edge from among at least one candidate node and at least one candidate edge corresponding to the at least one candidate node determined while the moving object 710 moves from a previous node to the node.

For example, when a current location of the moving object 710 is on the commit node 713, the electronic device may determine the optimal node and the optimal edge from among the at least one candidate node 731 and/or 733 and at least one candidate edge corresponding to the at least one candidate node 731 and/or 733 determined while the moving object moves from the initial node, which is a previous node of the commit node 713, to the commit node 713. For example, the candidate node 733 may be determined to be the optimal node.

The electronic device may determine an optimal path by repeating the above-described operations when a complete path does not exist when an optimal node and an optimal edge are determined in the iterative phase. For example, the electronic device may update the candidate node 733 to be a commit node and determine a candidate node 741 within a first distribution 740.

Referring to FIG. 8, an example in which a complete path exists when an optimal node and an optimal edge are determined in the iterative phase is illustrated.

In FIG. 8, a moving object 810 departing from an initial position is illustrated. When the initial phase is terminated, the moving object 810 may drive to a commit node (e.g., a first optimal node) along a commit edge (e.g., a first optimal edge) corresponding to the commit node.

The electronic device may determine a candidate node that may be determined as a next optimal node (e.g., the second optimal node) while the moving object 810 moves along the commit edge to the commit node and generate a candidate edge corresponding to the candidate node. The electronic device may repeat the generating of the candidate edge and the determining of the candidate node while the moving object 810 moves along the commit edge to the commit node.

The candidate node may be determined in a target tree. For example, according to the example of FIG. 6, a candidate node 813 may be determined near the target tree by satisfying the first interval. The commit node and the candidate node 813 may be connected to generate a candidate edge 811. The candidate edge 811 may be a complete path.

When the complete path is determined, in the next iterative phase, the optimal edge and optimal node may be determined to be an edge and a node corresponding to the complete path according to the example of FIG. 5. For example, the candidate node 813 and the candidate edge 811 may be determined to be the optimal node (e.g., the second optimal node) and the optimal edge (e.g., a second optimal edge).

When the complete path is determined, in an iterative phase, optimization of the complete path may be performed to determine an optimal path.

The electronic device may input obstacle information, the target node, nodes of the complete path, and edges of the complete path to an AI model while the moving object 810 moves to the first optimal node.

The AI model may generate a first distribution, a confidence of the first distribution, and a second distribution based on the obstacle information, the target node, the nodes of the complete path, and the edges of the complete path.

The electronic device may generate a candidate node and a candidate edge by performing sampling based on an output of the AI model. For example, a candidate node 823 and a candidate edge 821 may be generated.

The electronic device may perform optimization for a predetermined complete path using the candidate node 823 and the candidate edge 821. For example, the complete path may be updated with the candidate node 823 and the candidate edge 821.

Through the same method, the electronic device may generate a candidate node 833 and a candidate edge 831, and the electronic device may perform optimization for a predetermined complete path using the candidate node 833 and the candidate edge 831. For example, the complete path may be updated with the candidate node 833 and the candidate edge 831.

The electronic device may determine an optimal path with lower cost through optimization. Hereinafter, an example of an AI model is described.

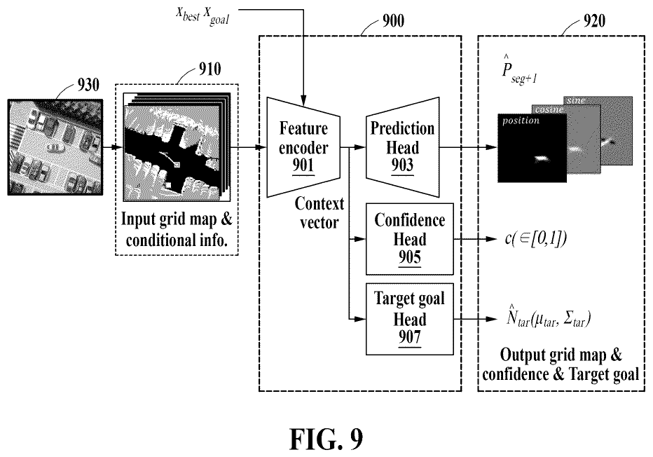

FIG. 9 illustrates an example of an artificial intelligence model.

Referring to FIG. 9, an example of an AI model 900 that outputs a first distribution, a confidence of the first distribution, and a second distribution is illustrated.

When an optimal path for a moving object to perform parking through autonomous driving is determined, the electronic device may preprocess an image 930 to generate input data 910 for input to an AI model 900.

The input data 910 may include five channels of data. A first channel may include information on cells occupied by obstacles in a plurality of cells into which the image is divided. A second channel may include information on cells (e.g., cells for which it is unclear whether driving is possible) for which it is unclear whether they are occupied by obstacles in a plurality of cells into which the image is divided. A third channel may include information on a commit edge followed by the moving object. A fourth channel may include information on an end point (e.g., a commit node and/or an optimal node) of a commit edge. A fifth channel may include information on a location and direction of a target node. The first and second channels may correspond to obstacle information. The third and fourth channels may correspond to information on the optimal node and optimal edge. The fifth channel may correspond to information on the target node.

The AI model 900 may receive the input data 910. The AI model 900 may include an encoder and three decoders. For example, the AI model 900 may include a feature encoder 901. The AI model 900 may include a prediction head decoder 903, a confidence head decoder 905, and a target goal head decoder 907.

The feature encoder 901 may process the input data 910 through a convolution block. In an intermediate phase, conditional information (e.g., information on an optimal node x_{best} and information on a target node X_{goal}) may be merged into each channel. In the intermediate phase, each channel may include conditional information. The conditional information may allow the location and direction of the optimal node and the target node to not be forgotten during a convolution operation. The feature encoder 901 may output a context vector to be input to each decoder.

The prediction head decoder 903 may output a first distribution \hat{P}_{seg+1} based on the context vector. The confidence head decoder 905 may output a confidence [symbol] of the first distribution. The target goal head decoder 907 may output a second distribution [symbol] ₜₐᵣ using a Gaussian distribution (μₜₐᵣ, Σ_{xy}).

The confidence [symbol] may also be used for training the AI model 900. For example, the AI model 900 may receive a penalty according to the confidence [symbol] . For example, a lower confidence may result in a higher penalty.

The AI model 900 may be trained to output a low confidence when outputting a first distribution with low accuracy in a driving environment where there is uncertainty. The AI model 900 may be trained to output a high confidence when outputting a first distribution with high accuracy in a driving environment where there is little uncertainty.

The output of the AI model 900 may be used for sampling a candidate node.

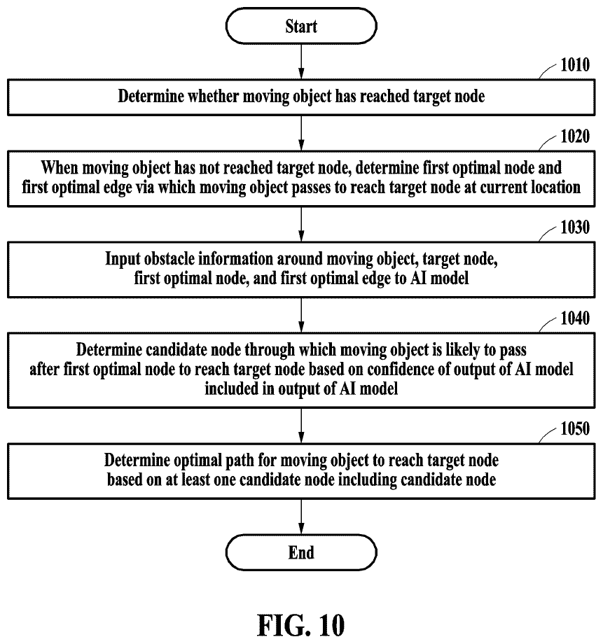

FIG. 10 illustrates an operating method of an electronic device.

Operations 1010 to 1050 of FIG. 10 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein. The operations illustrated in FIG. 10 may be performed by at least one component of the electronic device. For example, the electronic device may perform the following operations when instructions included in the memory are individually and/or collectively executed by a processor. The processor may include at least one of a host processor and an accelerator.

In operation 1010, the electronic device may determine whether a moving object has reached a target node.

In operation 1020, when the moving object has not reached the target node, the electronic device may determine a first optimal node and a first optimal edge through which the moving object passes to reach the target node at current location.

In operation 1030, the electronic device may input obstacle information around the moving object, the target node, the first optimal node, and the first optimal edge to an AI model.

In operation 1040, the electronic device may determine a candidate node through which the moving object is likely to pass after the first optimal node to reach the target node based on a confidence of an output of the AI model included in the output of the AI model.

In operation 1050, the electronic device may determine an optimal path for the moving object to reach the target node based on at least one candidate node including the candidate node.

A detailed description of operations 1010 to 1050 is omitted as it is described above with reference to FIGS. 1 to 9.

The present disclosure may minimize the determination of narrow areas where environmental changes may occur and/or uncertainty may exist by generating in advance a target tree including target edges that reach a target node. The target edges may be paths planned in advance to exit narrow areas where environmental changes may occur and/or uncertainty may exist. When a moving object reaches a target edge, the moving object may simply follow the target edge without having to search for a separate path.

The electronic device and method of one or more embodiments may determine a robust optimal path by distinguishing the uncertainty of a driving environment that occurs due to the driving of the moving object by utilizing a confidence of an output of an AI model. For example, when the uncertainty of the driving environment is relatively low, a high confidence may be output, and many candidate nodes may be sampled from a distribution output by the AI model to determine the optimal path. For example, when the uncertainty of a driving environment is relatively high, a low confidence may be output, and the optimal path may be determined by sampling many candidate nodes through uniform sampling rather than the distribution output by the AI model.

The electronic devices, host processors, memories, accelerators, electronic device 100, host processor 110, memory 120, and accelerator 130 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-10 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining whether a moving object has reached a target node;
in response to the moving object not reaching the target node, determining a first optimal node and a first optimal edge through which the moving object passes to reach the target node from a current location of the moving object;
inputting obstacle information around the moving object, the target node, the first optimal node, and the first optimal edge to an artificial intelligence (AI) model;
determining a candidate node through which the moving object is likely to pass after reaching the first optimal node to reach the target node, based on a confidence of an output of the AI model included in the output of the AI model; and
determining an optimal path for the moving object to reach the target node based on one or more candidate nodes including the candidate node.

2. The method of claim 1, wherein the AI model is configured to output a first distribution of the optimal path based on the first optimal node, the confidence of the first distribution, and a second distribution of the optimal path based on a target tree generated from the target node, based on the obstacle information, the target node, the first optimal node, and the first optimal edge.

3. The method of claim 1, wherein the determining of the first optimal node and the first optimal edge comprises, in response to the current location of the moving object being on an edge, until the moving object reaches a node connected to the edge, determining the node and the edge to be the first optimal node and the first optimal edge, respectively.

4. The method of claim 1, wherein the determining of the first optimal node and the first optimal edge comprises, in response to the current location of the moving object being on a node, determining the first optimal node and the first optimal edge among one or more candidate nodes determined while the moving object moves from a previous node of the node to the node and one or more candidate edges corresponding to the one or more candidate nodes.

5. The method of claim 1, further comprising determining the one or more candidate nodes by repeating the determining of the first optimal node and the first optimal edge, the inputting to the AI model, and the determining of the candidate node, until the moving object reaches the first optimal node.

6. The method of claim 2, wherein the determining of the candidate node comprises determining the candidate node based on any one of the first distribution, the second distribution, and an area comprising the first distribution and the second distribution.

7. The method of claim 6, wherein the candidate node is more likely to be determined from the first distribution, the higher the confidence is.

8. The method of claim 6, wherein the determining of the candidate node comprises any one of:
determining the candidate node based on the first distribution, in response to a random value being less than a second parameter;
determining the candidate node based on the second distribution, in response to the random value being greater than or equal to the second parameter and less than a predetermined value; and
determining the candidate node based on the area comprising the first distribution and the second distribution, in response to the random value being greater than or equal to the predetermined value.

9. The method of claim 8, wherein
the second parameter corresponds to a probability of determining the candidate node from the second distribution, and
the predetermined value is determined based on the confidence of the output of the AI model, the second parameter, and a first parameter corresponding to a probability of determining the candidate node from the first distribution with a maximum usage ratio.

10. The method of claim 1, wherein the determining of the optimal path comprises:
in response to the moving object reaching the first optimal node, determining a second optimal node among the one or more candidate nodes;
removing candidate nodes other than the second optimal node from among the one or more candidate nodes, and removing candidate edges other than a second optimal edge corresponding to the second optimal node from among one or more candidate edges corresponding to the one or more candidate nodes; and
determining the optimal path based on the second optimal node and the second optimal edge.

11. The method of claim 10, wherein the determining of the second optimal node comprises, in response to there being no candidate node connected to the target tree generated from the target node among one or more candidate nodes, determining a candidate node configured to be connected to the target node by the shortest distance among the one or more candidate nodes to be the second optimal node and the second optimal edge.

12. The method of claim 10, wherein the determining of the second optimal node comprises, in response to there being a candidate node connected to the target tree generated from the target node among the one or more candidate nodes, determining the candidate node connected to the target tree to be the second optimal node.

13. An electronic device, comprising:
memory storing instructions; and
at least one processor configured to execute the instructions,
wherein the instructions, when executed by the at least one processor individually or collectively, cause the electronic device to:
determine whether a moving object has reached a target node;
in response to the moving object not reaching the target node, determine a first optimal node and a first optimal edge through which the moving object passes to reach the target node from a current location of the moving object;
input obstacle information around the moving object, the target node, the first optimal node, and the first optimal edge to an artificial intelligence (AI) model;
determine a candidate node through which the moving object is likely to pass after reaching the first optimal node to reach the target node based on a confidence of an output of the AI model included in the output of the AI model; and
determine an optimal path for the moving object to reach the target node based on one or more candidate nodes including the candidate node.

14. The electronic device of claim 13, wherein the AI model is configured to output a first distribution of the optimal path based on the first optimal node, the confidence of the first distribution, and a second distribution of the optimal path based on a target tree generated from the target node, based on the obstacle information, the target node, the first optimal node, and the first optimal edge.

15. The electronic device of claim 13, wherein the instructions, when executed by the at least one processor individually or collectively, cause the electronic device to, in response to the current location of the moving object being on an edge, until the moving object reaches a node connected to the edge, determine the node and the edge to be the first optimal node and the first optimal edge, respectively.

16. The electronic device of claim 13, wherein the instructions, when executed by the at least one processor individually or collectively, cause the electronic device to, in response to the current location of the moving object being on a node, determine the first optimal node and the first optimal edge among one or more candidate nodes determined while the moving object moves from a previous node of the node to the node and one or more candidate edges corresponding to the one or more candidate nodes.

17. The electronic device of claim 13, wherein the instructions, when executed by the at least one processor individually or collectively, cause the electronic device to, determine the one or more candidate nodes by repeating the determining of the first optimal node and the first optimal edge, the inputting to the AI model, and the determining of the candidate node, until the moving object reaches the first optimal node.

18. The electronic device of claim 13, wherein the instructions, when executed by the at least one processor individually or collectively, cause the electronic device to, determine the candidate node based on any one of the first distribution, the second distribution, and an area comprising the first distribution and the second distribution.

19. The electronic device of claim 13, wherein the instructions, when executed by the at least one processor individually or collectively, cause the electronic device to,
in response to the moving object reaching the first optimal node, determine a second optimal node among the one or more candidate nodes,
remove candidate nodes other than the second optimal node from among the one or more candidate nodes, and remove candidate edges other than a second optimal edge corresponding to the second optimal node from among one or more candidate edges corresponding to the one or more candidate nodes, and
determine the optimal path based on the second optimal node and the second optimal edge.

20. A processor-implemented method comprising:
inputting, to an artificial intelligence (AI) model, obstacle information around a moving object, a target node, a first optimal node, and a first optimal edge through which the moving object passes to reach the target node from a current location of the moving object;
determining, based on a confidence included in an output of the AI model, a candidate node through which the moving object is likely to pass after reaching the first optimal node to reach the target node, based on a selected one of a first distribution of the optimal path determined based on the first optimal node, a second distribution of the optimal path determined based on a target tree generated from the target node, and an area comprising the first distribution and the second distribution; and
determining an optimal path for the moving object to reach the target node based on one or more candidate nodes including the candidate node.
